(19) United States
(12) Patent Application Publication
(10) Pub. No.: US 2026/0229054 A1
(43) Pub. Date: Aug. 6, 2026

(54) Data-Driven Optical Character Recognition (OCR) Utilizing Multiple OCR Engines

(71) Applicant: OPEN TEXT INC., Menlo Park, CA (US)

(72) Inventors: Ralf Rainer Bubeck, Konstanz (DE); Matthias Seichter, Konstanz (DE)

(21) Appl. No.: 19/047,362

(22) Filed: Feb. 6, 2025

(51) Int. Cl. G06V 30/19; G06V 10/75; G06V 10/776

(52) U.S. Cl. CPC G06V 30/1916; G06V 10/75; G06V 10/776; G06V 30/19007

(57) ABSTRACT

Systems and methods for extrinsic data driven OCR utilizing multiple OCR engines are disclosed. Embodiments as disclosed herein may determine data on OCR engines employed by an OCR system during an OCR engine evaluation process to generate extrinsic data on each OCR engine. This extrinsic data can then be used by embodiments of OCR systems employing these multiple OCR engines when performing OCR on an image.

### TECHNICAL FIELD

This disclosure relates generally to optical character recognition (OCR) systems and methods. In particular, this disclosure relates to OCR systems that employ multiple OCR engines. Even more specifically, this disclosure relates to OCR systems and methods that utilize data on those multiple OCR engines to drive the OCR process.

### BACKGROUND

Optical character recognition (OCR) is the process of identifying characters from an image. In other words, OCR converts images (e.g., including images of characters) into machine-encoded characters. OCR may be performed on almost any type of image such as, for example, electronically generated images generated from application programs, cameras, scanners, electronic faxes, when a user is using a pointing device or their finger to handwrite characters in (or on) an electronic device, or in other contexts. Because of a variety of factors (e.g., clarity of image, characters or background, script or font used, language being recognized, etc.), OCR may have challenges in correctly identifying characters.

What is desired, therefore, are improved systems and methods for OCR.

### SUMMARY

As discussed, OCR identifies characters in an image to convert (e.g., the characters included in that) image into machine-encoded characters (referred to without loss of generality herein as text). Typically, these OCR systems employ an OCR engine to perform the recognition of the characters in an image being processed. Certain factors may present problems for these OCR engines and may cause characters to be incorrectly identified by that OCR engine.

Thus, although modern OCR technology is capable of handling a wide variety of images, there is no single OCR engine that performs equally well on all images (e.g., even for a given single language or alphabet). As such, OCR systems may employ multiple OCR engines in tandem to process an image and generate an output comprising a final set of characters recognized from that image.

To illustrate in more detail, when using multiple OCR engines, each OCR engine may process the same image and generate a corresponding output. Once each OCR engine has processed the image, the OCR system must align the outputs from the different OCR engines (e.g., the characters recognized from that image by each of the multiple OCR engines) to generate an output of the OCR system comprising a final set of characters recognized from that image.

To combine the outputs from the multiple OCR engines and select the final characters for the output of the OCR system, OCR systems may employ a variety of strategies. Almost all of these strategies have a common flaw. Namely, they all must utilize intrinsic data to drive the character selection process. In other words, all the data that is utilized in making a selection of which character to include in a final output for an image is based on the output of those multiple OCR engines themselves. Not only is there thus a paucity of data to use in making character selection, the data utilized may itself be compromised, as it originates from the very OCR engines which are generating the output from which a character may be selected. Just as humans may be blind to their own faults, the confidence values generated by an OCR engine may not accurately reflect the weaknesses (or strengths) of that OCR engine. Moreover, many OCR engines may not be capable of recognizing certain characters at all, which may skew both the characters output by the OCR engine, and the confidence levels associated with those characters. Accordingly, relying on this small slice of intrinsic data, which may itself be generated by the very OCR engines whose output it is desired to evaluate, can lead to poor recognition accuracy by OCR systems, especially in challenging scenarios like noisy scans, unusual fonts, or poor image quality.

To ameliorate these issues, among other ends, attention is now directed to systems and methods for extrinsic data driven OCR utilizing multiple OCR engines. Embodiments as disclosed herein may determine data on each OCR engine employed by an OCR system during an OCR engine evaluation process to generate extrinsic data on each OCR engine. This extrinsic data for an OCR engine may comprise extrinsically generated performance data on that OCR engine, including data related to an evaluation of the performance of that OCR engine on an evaluation dataset.

This extrinsic data can then be used by embodiments of OCR systems employing these multiple OCR engines when performing OCR on an image. Specifically, the multiple OCR engines may be applied to the image to generate an output from each OCR engine. The extrinsic data may be used to evaluate the output generated by each of these OCR engines to select characters from outputs of the different OCR engines to generate an output of the OCR system comprising a final set of characters recognized for that image. In some embodiments, in the case of a conflict between the characters recognized by multiple OCR engines (e.g., the characters for a same location or slot in the outputs from two or more OCR engines are different) the extrinsic data may be used to determining which of the (different) character to select for the final set of characters recognized for the image.

This selection process may include determining a voting value for each OCR engine based on the respective character recognized by that OCR engine and the extrinsic data. These voting values can be based on, for example, the performance data for that OCR engine regarding performance of that OCR engine relative to the character it recognized. The voting values for each OCR engine (e.g., for their respective characters) can then be used to select which of the two or more different characters recognized by the two or more OCR engines should be selected for inclusion in the final set of characters recognized for the image.

Certain embodiments may therefore obtain a first OCR engine output resulting from performing OCR on an image with a first OCR engine and obtain a second OCR engine output resulting from performing OCR on the image with a second OCR engine. A first trust list associated with the first OCR engine can be obtained, wherein the first trust list comprises first extrinsic data on the first OCR engine, the first extrinsic data determined based on performance of the first OCR engine on an evaluation dataset. Likewise, a second trust list associated with the second OCR engine can be obtained, wherein the second trust list comprises second extrinsic data on the second OCR engine, the second extrinsic data determined based on performance of the second OCR engine on an evaluation dataset. A final set of characters recognized for the image can then be determined based on the first OCR engine output, the second OCR engine output, the first trust list and the second trust list.

The first trust list may, for example, comprise a set of characters, each character associated with a first ground truth count of that character in the evaluation data set, a first correct character count of instances of that character correctly recognized by the first OCR engine in the evaluation dataset and a first character confidence value for that character indicating an average of character confidence values reported by the first OCR engine in association with the evaluation dataset. The second trust list may similarly comprise the set of characters, each character associated with a second ground truth count of that character in the evaluation data set, a second correct character count of instances of that character correctly recognized by the second OCR engine in the evaluation dataset and a second character confidence value for that character indicating an average of character confidence values reported by the second OCR engine in association with the evaluation dataset.

In one embodiment, selecting a final set of characters recognized for the image comprises obtaining a first character recognized by the first OCR engine from the first OCR engine output, obtaining a corresponding second character recognized by the second OCR engine from the second OCR engine output, determining a first voting value for the first OCR engine based on performance of the first OCR engine associated with the first character or second character as determined from the first trust list and determining a second voting value for the second OCR engine based on performance of the second OCR engine associated with the first character or second character as determined from the second trust list. The first voting value and the second voting value can then be compared to select one of the first or second characters.

In some embodiments, the first voting value is based on a first same trust value based on performance of the first OCR engine associated with the first character and a first other trust value based on performance of the first OCR engine associated with the second character and the second voting value is based on a second same trust value based on performance of the second OCR engine associated with the second character and a second other trust value based on performance of the second OCR engine associated with the first character.

In a particular embodiment, the first voting value is based on a first trust competition value comprising a ratio between the first same trust value and the first other trust value and the second voting value is based on a second trust competition value comprising a ratio between the second same trust value and the second other trust value. The first voting value can, for example, be determined based on a first character confidence value determined by the first OCR engine for the first character and the second voting value may be determined based on a second character confidence value determined by the second OCR engine for the second character.

In a specific embodiment, the first character confidence value is normalized by a first overall confidence level for the first OCR engine determined based on the first trust list and the second character confidence value is normalized by a second overall confidence level for the second OCR engine determined based on the second trust list.

As can be seen then, embodiments may allow an OCR system that employs multiple OCR engines to select from characters generated by those multiple OCR engines based on extrinsic data determined for those OCR engines. As such, embodiments as disclosed herein may offer a number of advantages. Namely, embodiments may allow the more accurate selection of characters to include in character recognized content generated from an image, resulting in more accurate character recognized content generated from performing OCR on images. Further, as embodiments may utilize extrinsic data generated on these OCR engines during an (e.g., asynchronous or orthogonal) evaluation process using an evaluation dataset, this extrinsic data may be updated as desired (e.g., based on a new evaluation dataset, based on changes to an OCR engine, etc.). Thus, selection of characters in an OCR system may be rapidly tailored to changes in OCR engines through the generation and use of new extrinsic data for those changed OCR engines.

Moreover, the changes or adaptations to these OCR systems may be accomplished without significant downtime for an OCR system, as new extrinsic data may be determined asynchronously with respect to operation of the OCR system and deployed to an operational OCR system with minimal interruption to, or interference with, the operation of that OCR system. Additionally, as such extrinsic data for an OCR engine may be determined asynchronously to the operation of deployed OCR systems, it may be determined a single time and deployed to all (or a subset of) deployed OCR systems that employ that OCR engine. Furthermore, as a result of such an architecture, an easily extensible framework for OCR systems is provided whereby new (e.g., additional) or altered OCR engines may be incorporated into deployed OCR systems with minimal effort using the same character selection mechanisms and extrinsic data generated for those new or altered OCR engines.

These, and other, aspects of the invention will be better appreciated and understood when considered in conjunction with the following description and the accompanying drawings. The following description, while indicating various embodiments of the invention and numerous specific details thereof, is given by way of illustration and not of limitation. Many substitutions, modifications, additions or rearrangements may be made within the scope of the invention, and the invention includes all such substitutions, modifications, additions or rearrangements.

### BRIEF DESCRIPTION OF DRAWINGS

The drawings accompanying and forming part of this specification are included to depict certain aspects of the invention. A clearer impression of the invention, and of the components and operation of systems provided with the invention, will become more readily apparent by referring to the exemplary, and therefore non-limiting, embodiments illustrated in the drawings, wherein identical reference numerals designate the same components. Note that the features illustrated in the drawings are not necessarily drawn to scale.

FIG. 1 (comprising of FIGS. 1A and 1B that are collectively referred to as “FIG. 1”) is a block diagram of one embodiment of an OCR system.

FIG. 2 depicts examples of trust lists for OCR engines.

FIG. 3 is a flow diagram of one embodiment of a method for selecting characters in an OCR system.

FIG. 4 is a block diagram of an OCR voting and selection engine.

FIG. 5 is a flow diagram of one embodiment of a method for selecting characters in an OCR system.

FIG. 6 is a flow diagram of one embodiment of a method for selecting characters in an OCR system.

### DETAILED DESCRIPTION

The disclosure and various features and advantageous details thereof are explained more fully with reference to the exemplary, and therefore non-limiting, embodiments illustrated in the accompanying drawings and detailed in the following description. It should be understood, however, that the detailed description and the specific examples are given by way of illustration only and not by way of limitation. Descriptions of known programming techniques, computer software, hardware, operating platforms and protocols may be omitted so as not to unnecessarily obscure the disclosure in detail. Various substitutions, modifications, additions and/or rearrangements within the spirit and/or scope of the underlying inventive concept will become apparent to those skilled in the art from this disclosure.

Before discussing embodiments in detail, some context may be useful. As discussed, OCR identifies characters in an image to convert (e.g., the characters included in that) image into machine-encoded characters (referred to without loss of generality herein as text). Typically, these OCR systems employ an OCR engine to perform the recognition of the characters in an image being processed. Certain factors may present problems for these OCR engines and may cause characters to be incorrectly identified by that OCR engine. These factors may include the clarity of the image, characters or background, on which OCR is being performed, the script or font used for the characters included in the image on which OCR is being performed, the alphabet or language associated with the characters being recognized, or other factors.

Thus, although modern OCR technology is capable of handling a wide variety of images, there is no single OCR engine that performs equally well on all images (e.g., even for a given single language or alphabet). Each OCR engine may thus have its own strengths and weaknesses and commensurately different OCR engines tend to differ in the accuracy on different images, and in the errors that may occur with respect to the same image.

As such, OCR systems may employ multiple OCR engines in tandem to process an image and generate an output comprising a final set of characters recognized from that image. These OCR engines could be based on different technologies, such as traditional rule-based OCR or machine learning-based OCR. OCR systems that use multiple OCR engines employ some form of strategy that combines the output of the different OCR engines to improve accuracy.

To illustrate in more detail, when using multiple OCR engines, each OCR engine may process the same image and generate a corresponding output. This output from an OCR engine comprises a set of characters (e.g., character predictions) along with an associated confidence level (also referred to herein as a confidence value) for those characters. This confidence level may be a numeric value (usually between 0 and 1, or 0 and 100) that indicates how certain the OCR engine is that the particular corresponding character (or set of characters) has been correctly recognized. It will be noted here that certain OCR engines (e.g., cloud-based OCR engines) may only provide confidences levels on some collection of characters (e.g., words, lines, etc.). In such cases, this confidence level for the collection of characters can be simply inherited, or imputed, to all characters of that respective collection of characters.

Once each OCR engine has processed the image, the OCR system must align the outputs from the different OCR engines (e.g., the characters recognized from that image by each of the multiple OCR engines) to generate an output of the OCR system comprising a final set of characters recognized from that image. This alignment process involves matching characters or blocks of recognized characters from the different OCR engines that correspond to the same location or region in the original image and selecting a character to include in the final output of the OCR system from the characters output by the different OCR engines.

To combine the outputs from the multiple OCR engines and select the final characters for the output of the OCR system, OCR systems may employ a variety of strategies. These strategies are usually fusion based strategies that take into account the confidence scores from each OCR engine. For example, one alignment strategy may be a majority rules strategy. Here, for a given location (e.g., slot or space), the characters output by each OCR engine for that location are compared and the most common character is selected for that position. In some cases, each OCR engine's character is given a weight based on the associated confidence value assigned to that character by the OCR engine. In this manner, if there is no most common character, the character with the highest weight may be selected as the final character.

In other approaches, instead of simply selecting the character with the highest confidence from any of the OCR engines, an OCR system may utilize a more sophisticated probabilistic approach to fuse the different character (predictions) from each OCR engine. Each character prediction from the engines is combined into a probability distribution, and the final output is the character with the highest aggregated probability after taking the confidence levels into account.

As may be realized, all these strategies have a common flaw. Namely, they all must utilize intrinsic data to drive the character selection process. In other words, all the data that is utilized in making a selection of which character to include in a final output for an image is based on the output of those multiple OCR engines themselves. Not only is there thus a paucity of data to use in making character selection, the data utilized may itself be compromised, as it originates from the very OCR engines which are generating the output from which a character may be selected. Just as humans may be blind to their own faults, the confidence values generated by an OCR engine may not accurately reflect the weaknesses (or strengths) of that OCR engine. Moreover, many OCR engines may not be capable of recognizing certain characters at all, which may skew both the characters output by the OCR engine, and the confidence levels associated with those characters. Accordingly, relying on this small slice of intrinsic data, which may itself be generated by the very OCR engines whose output it is desired to evaluate can lead to poor recognition accuracy by OCR systems, especially in challenging scenarios like noisy scans, unusual fonts, or poor image quality.

To ameliorate these issues, among other ends, attention is now directed to systems and methods for extrinsic data driven OCR utilizing multiple OCR engines. Embodiments as disclosed herein may determine data on each OCR engine employed by an OCR system during an OCR engine evaluation process to generate extrinsic data on each OCR engine. This extrinsic data (generally referred to herein as a trust list) for an OCR engine may comprise extrinsically generated performance data on that OCR engine, including (e.g., statistical) data related to an evaluation of the performance of that OCR engine on an evaluation dataset. This statistical data for an OCR engine may include, for example, performance data for that OCR engine regarding performance of that OCR engine relative to its performance on recognition of individual characters as determined from the actual composition of the evaluation dataset.

This extrinsic data can then be used by OCR systems employing these multiple OCR engines when performing OCR on an image. Specifically, the multiple OCR engines may be applied to the image to generate an output from each OCR engine. The extrinsic data may be used to evaluate the output generated by each of these OCR engines to select characters from outputs of the different OCR engines to generate an output of the OCR system comprising a final set of characters recognized for that image. These characters can be, for example, made available for a user in association with the image (e.g., in an application), saved as a separate document, or otherwise utilized. In some embodiments, in the case of a conflict between the characters recognized by multiple OCR engines (e.g., the characters for a same location or slot in the outputs from two or more OCR engines are different) the extrinsic data may be used to determining which of the (different) character to select for the final set of characters recognized for the image.

This selection process may include determining a voting value for each OCR engine based on the respective character recognized by that OCR engine and the extrinsic data. These voting values can be based on, for example, the performance data for that OCR engine regarding performance of that OCR engine relative to the character it recognized. The voting values for each OCR engine (e.g., for their respective characters) can then be used to select which of the two or more different characters recognized by the two or more OCR engines should be selected for inclusion in the final set of characters recognized for the image.

To generate extrinsic data for these OCR engines an evaluation dataset may be utilized. In particular, the evaluation dataset may comprise a set of images along with ground truth data corresponding to the set of images. This ground truth data may specify the actual characters included in each of the set of images of the evaluation dataset, the location of those characters in the set of images of the evaluation dataset, or any other data that may allow the determination of the correctness of a character determined by an OCR engine for an image of the set of images of the evaluation dataset.

Thus, for an OCR engine of the multiple OCR engines to be utilized in an OCR system a trust list associated with that OCR engine may be generated by applying that OCR engine to each of the set of images of the evaluation dataset to generate an OCR engine output for that OCR engine on each image of the evaluation dataset. The OCR engine output generated by an OCR engine for an image of the evaluation dataset may include a set of characters (e.g., character predictions) along with an associated confidence level (also referred to herein as a confidence value) for those characters. These confidence values can, for example, be on a scale from 0-100.

The ground truth data on the evaluation data set can then be used to evaluate the OCR engine output for the set of images of the evaluation dataset generated by an OCR engine to generate the trust list for that OCR engine. In some embodiments, for example, the number of occurrences of each of a set of characters in the set of images of the evaluation dataset as included in the ground truth data (e.g., along with the location of those characters in the set of images of the evaluation dataset) may be used to determine a count of the number of occurrences of each character in the set of images of the evaluation dataset (e.g., the actual number of occurrences of each character as indicated in the ground truth). A count of the number of occurrences of each character that were correctly recognized by the OCR engine can be determined from the OCR engine output generated from the images of the evaluation dataset (e.g., and the ground truth data). In some embodiments, only one to one character matches between the OCR engine output and the ground truth data may be included in the character counts for the trust list being generated. In this manner, no insertions, deletions or segmentation errors may be counted. Additionally, (e.g., recognized) blanks may be discarded from such counts as well.

Thus, a generated trust list for an OCR engine may include, for each of a set of characters, the number of occurrences of that character in the evaluation dataset (as determined from the ground truth data, referred to as the ground truth count) and a number of occurrences of that character that were correctly recognized by that OCR engine in the evaluation dataset (e.g., as determined from the OCR engine output generated by that OCR engine and the ground truth data for the evaluation dataset, referred to as the correct count).

The (e.g., statistical) data included in the trust list may also include a character confidence value for each of the set of characters. The character confidence value for a character for an OCR engine may be determined from the confidence levels generated by the OCR engine for occurrences of that character in the OCR engine output. In one particular embodiment, the character confidence value may be an average confidence value for that character output by the OCR engine for instances where that character was correctly recognized by the OCR engine in the set of images of the evaluation dataset. The character confidence value can thus be a sum of all the confidence values generated by the OCR engine for that character (as included in the OCR engine output) for instances of that character that were correctly recognized by the OCR engine, divided by the number of occurrences of that character that were correctly recognized (e.g., as determined from the OCR engine output for that OCR engine and the ground truth data).

Moreover, these character confidence values for individual characters may be utilized to generate a confidence value for the OCR engine (also referred to as an overall, or OCR engine, confidence value). A confidence value for an OCR engine may be determined as an average of the confidence values for all of the individual character confidence values for that OCR engine as included in the trust list. Thus, the confidence value for the OCR engine is a sum of the individual character confidence values included in the trust list divided by the number of characters in the trust list.

Moreover, in some embodiments, the trust list for an OCR engine may include characters that the OCR engine may not be capable of recognizing. For these characters (that the OCR engine cannot recognize), the trust list may include that character, along with the number of occurrences of that character in the evaluation dataset as indicated in the ground truth data. The number of correctly recognized occurrences of that character and the character confidence value for that character may be specified as zero in the trust list.

These generated trust lists can then be used by OCR systems employing these multiple OCR engines when performing OCR on an image. According to embodiments, therefore, the trust lists generated for the OCR engines during an evaluation process may be deployed to (or included in) an OCR system employing the OCR engines associated with those trust lists.

In some embodiments, then an OCR system employing multiple OCR engines may receive an image and perform OCR on that image to generate a final set of characters recognized by that OCR system for that image. Initially then, each of the multiple OCR engines may be applied to the image to generate an output from each OCR engine. This OCR engine output from each of the OCR engines may include a set of characters recognized by the OCR engine (e.g., character predictions) and associated confidence values. Corresponding sets of characters in each OCR engine output (e.g., characters from each OCR engine output recognized by that OCR engine and corresponding to the same location or slot, etc.) can then be compared to select a character for inclusion (e.g., in that location or slot) in the final set of character recognized for that image.

Specifically, if the corresponding characters from each of the OCR engines (e.g., the recognized characters as included in the OCR engine output from each OCR engine such as those corresponding to the same slot or location) are the same, there may be no need to perform any further comparison and that character may be selected for inclusion in the final set of characters recognized for that image. If, however, there is a discrepancy between corresponding characters in the OCR engine output (e.g., the recognized characters from two or more OCR engines corresponding to the same location or slot are different characters), a comparison may be made between the OCR engines with respect to those different corresponding recognized characters to select one of the different corresponding characters for inclusion in the final set of characters recognized for that image.

This comparison may be based on voting values determined for each of the OCR engines based on the characters recognized by that (or the other) OCR engines and the trust lists including the extrinsic data determined for those OCR engines. These voting values for each of the OCR engines can then be compared to select a corresponding character from one of the OCR engines for inclusion in the final set of characters recognized for an image.

In one embodiment, these voting values may be based on trust values determined for each OCR engine, where those trust values are associated with the character recognized by that OCR engine or the character recognized by one of the other OCR engines. A trust value for an OCR engine with respect to a character may be based on the extrinsic data included in the trust list for that OCR engine. For example, a trust value for an OCR engine for a character may be a ratio of the number of instances of that character in the evaluation dataset (e.g., the ground truth count in the trust list) to the number of instances of that character in the evaluation dataset that were correctly recognized by that OCR engine in the evaluation dataset (e.g., the correct count in the trust list).

Thus, in one particular embodiment when performing a comparison between two different corresponding characters recognized in an image by two different OCR engines, two trust values may be determined for each of those OCR engines. The first trust value for an OCR engine may be a (same) trust value for the (e.g., first) OCR engine based on the (first) character recognized by that (e.g., first) OCR engine determined from the ground truth and correct counts for that (first) character in the (e.g., first) trust list associated with that (e.g., first) OCR engine. The second trust value may be an (other) trust value for that (e.g., first) OCR engine based on the (second) character recognized by the other (e.g., second) OCR engine determined from the ground truth and correct counts for that other (second) character in the (e.g., first) trust list associated with that (e.g., first) OCR engine. In some cases, a threshold value may be utilized to place a ceiling or a floor on a trust value. For example, a generated trust value may be compared to a minimum value threshold (0.7) and if the generated trust value is below that minimum value threshold, the trust value may be set to that minimum value (e.g., 0.7). This may allow embodiments to account for a scenario where an OCR cannot recognize certain characters, or other scenarios where a correct count for that character in the trust list for OCR engine may be zero.

The trust values can then be used to determine voting values for each OCR engine with respect to the corresponding characters recognized by those OCR engines to select one of the different corresponding characters for inclusion in the final set of characters recognized for that image. Specifically, in certain embodiments, a trust competition value for each OCR engine may be determined based on the trust values (e.g., the same trust value and the other trust value) determined for both OCR engines. This trust competition value for an (e.g., first) OCR engine may thus be a ratio between the same trust value for that (first) OCR engine (e.g., the trust value for that OCR engine on the character recognized by that OCR engine) and the other value for the other (second) OCR engine (e.g., the trust value for the other OCR engine on the character recognized by that (first) OCR engine). Thus, the trust competition value for one (e.g., a first) OCR engine is a value reflecting a level of trust on whether that (e.g., first) OCR engine is trusted more or less (e.g., has been determined to be more or less performant based on extrinsic data) than the (e.g., second) other OCR engine on the character that the (e.g., first) OCR engine recognize.

The trust competition values for determined for each OCR engine based on the respective recognized characters and the trust list (extrinsic data) for those OCR engines may then be utilized to determine the respective voting values for each OCR engine where those voting values may be compared to select one of the corresponding characters from one of the OCR engines for inclusion in the final set of characters recognized for an image. In one embodiment, for example, the trust competition value for an OCR engine may be used as the voting value for that OCR engine. However, in other embodiments the character confidence value for the character recognized by the OCR engines (e.g., as included in the trust list for that OCR engine) may be used in the generation of the voting trust for the OCR engine (e.g., the character confidence value for the respective character recognized by that OCR engine may be used in determining the voting value for that OCR engine). In some cases, this character confidence value may be normalized based on the (overall) confidence value for that OCR engine and this normalized character confidence value may be used in determining the voting value for that OCR engine.

Additionally, in certain embodiments a content confidence value may be utilized in determining the voting value for an OCR engine. This content confidence value may be determined by summing all the confidence values for all characters in the OCR engine output generated by that OCR engine for that image. Again, in certain instances this content confidence value may be normalized based on the (overall) confidence value for that OCR engine and this normalized content confidence value may be used in determining the voting value for that OCR engine. Moreover, in particular embodiments, the effect of this (e.g., normalized) content confidence value on the voting value determined for an OCR engine may be reduced by applying some reduction function (e.g., a square root) to the (e.g., normalized) content confidence value and using the result of this reduction function applied to the content confidence value in determining the voting value for the OCR engine.

The two voting values determined for the two different OCR engines in association with two different corresponding characters recognized in an image may then be used to determine which of those corresponding characters to select for inclusion in the final set of characters recognized for that image by the OCR system. For example, a direct comparison with the voting values may be used such that the character recognized by the OCR engine with the greatest voting value may be selected for inclusion in the final set of characters. Alternatively, a voting threshold may be used to bias the determination of which character to select in favor (or against) one of the OCR engines (e.g., when an OCR engine is a more, or less, trusted OCR engine). To illustrate, if one OCR engine is more trusted than another (second) OCR engine the character recognized by this less trusted (second) OCR engine may only be selected instead of the corresponding character recognized by the more trusted (first) OCR engine if the voting value determined for that (second) OCR engine is greater than the voting value determined for the (first) OCR engine by some amount (e.g., the voting threshold).

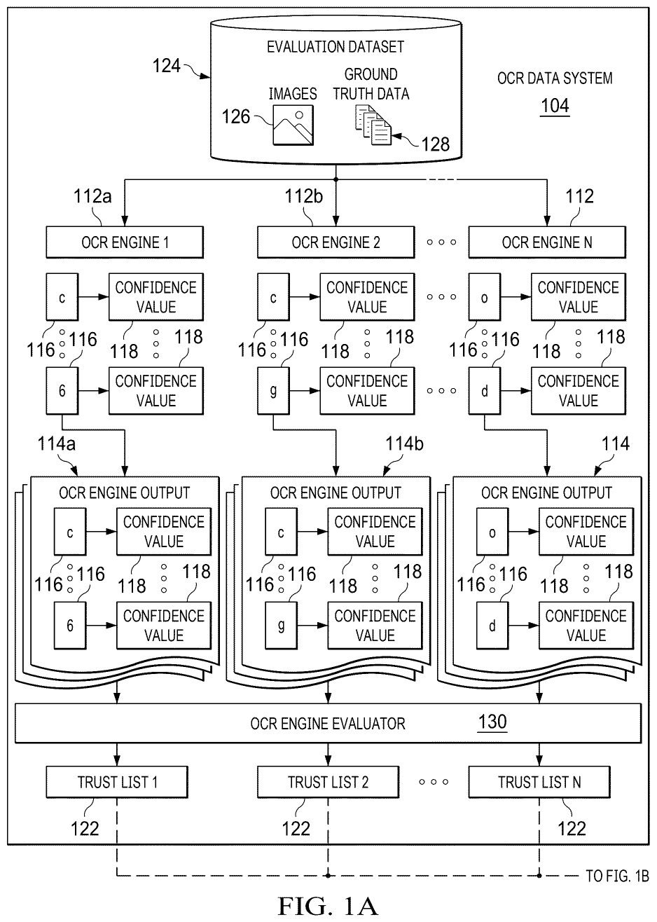

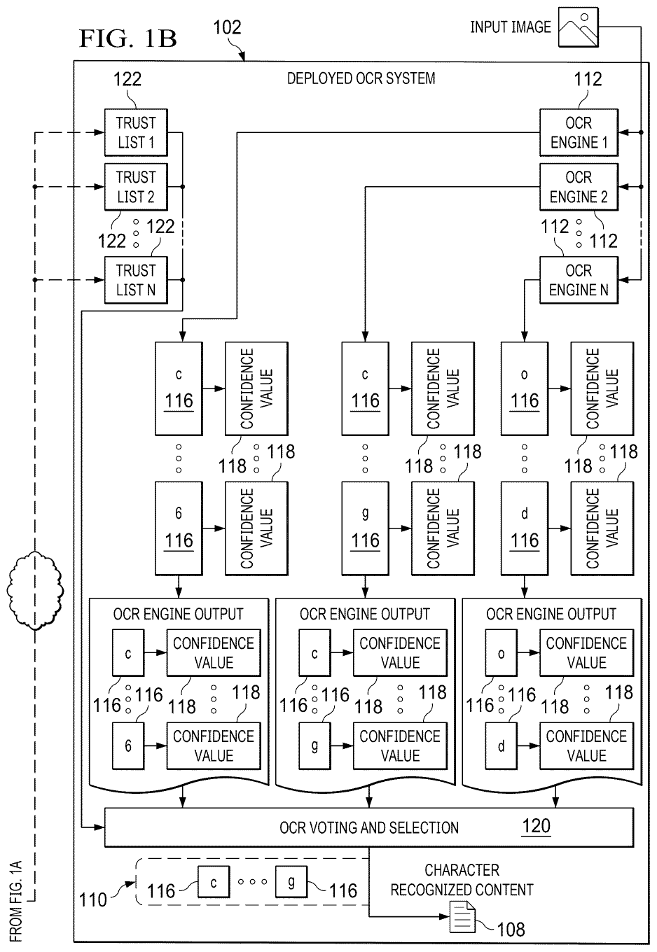

Referring now to FIG. 1, one embodiment of an OCR system is depicted. OCR system 100 may include a deployed OCR system 102 and an OCR data system 104. OCR system 102 and OCR data system 104 may, for example, be deployed on a standalone computing system or a computing platform, such as a distributed or cloud based computing platform and may communicate over one more computer networks, such as a LAN, WAN, the Internet or some other form of wired, wireless or cellular network. OCR system 102 may, for example, be incorporated into, or otherwise utilized with, one or more deployed document systems while OCR data system 104 may be deployed in a distributed or cloud based computing platform.

Deployed OCR system 102 may be an OCR system that is adapted to perform OCR on an image 106 and generate a final set of characters 110 recognized for that image. This final set of characters 110 for image 106 may be included in a character recognized document 108. Thus, the image data for the characters represented as image data in image 106 are replaced or supplemented in the character recognized document 108 with computer encoded characters. A computer encoded character is an encoding for text rather than image. For example, the computer encoded characters may be in Unicode, UTF-8, ISO-8859-1, Guo Biao (GB) code, Guo Biao Kuozhan (GBK) code, Big5 code, or other encodings.

Deployed OCR system 102 may utilize multiple OCR engines 112 to process an image and generate the final set of characters 110 to be included in character recognized content 108. These OCR engines 112 may, for example, be based on different technologies, such as traditional rule-based OCR or machine learning-based OCR. Thus, each OCR engine 112 may perform OCR on image 106 and generate a corresponding OCR engine output 114. The OCR engine output 114 output from an OCR engine 112 comprises a set of characters 116 determined from image 106 along with an associated confidence value 118 for those characters 116. This confidence value 118 may be a numeric value (usually between 0 and 1, or 0 and 100) that indicates how certain the OCR engine 112 is that the particular corresponding character 116 has been correctly recognized.

Once each OCR engine 112 has processed the image 106, OCR voting and selection engine 120 will evaluate the OCR engine outputs 114 from the different OCR engines 112 (e.g., the characters 116 recognized from the image by each of the multiple OCR engines 112 and their corresponding confidence values 118) to generate final set of characters 110 for inclusion in character recognized document 108 for the image 106. This evaluation process involves matching corresponding characters in different OCR engine outputs 114 from the different OCR engines 112 and selecting a character from these corresponding characters to include in the final set of characters 110.

This selection process may utilize trust lists 122 corresponding to each OCR engine 112 utilized by deployed OCR system 102. It will be noted that the term list is used here without loss of generality and is not intended to imply any particular format or storage mechanism. Each trust list 122 may include extrinsic data for a corresponding OCR engine 112 where that extrinsic data includes performance data on that OCR engine 112, including (e.g., statistical) data related to an evaluation of the performance of that OCR engine 112 on an evaluation dataset. This statistical data for an OCR engine 112 included in a trust list 122 may include, for example, performance data for that OCR engine 112 regarding performance of that OCR engine 112 associated with that OCR engine's performance on recognition of individual characters.

These trust lists 122 may, in one embodiment, be generated at a distinct or different system than deployed OCR system 102, and deployed to (used to provision or update), or included with (e.g., installed with), deployed OCR system 102. According to certain embodiments then, OCR system 100 may include OCR data system 104 adapted to generate trust lists 122 based on an evaluation dataset 124 during an OCR engine evaluation process.

Evaluation dataset 124 may comprise a set of images 126 including content that may include images or characters, along with ground truth data 128 corresponding to the set of images 126. This ground truth data 128 may specify the actual characters included in each of the set of images 126 of the evaluation dataset, the location of those characters in the set of images of the evaluation dataset, or any other data that may allow the determination of the correctness of a character determined by an OCR engine for an image of the set of images 126 of the evaluation dataset 124

OCR data system may include OCR engine evaluator 130 adapted to generate trust lists 122 for OCR engines 112 based on evaluation data set 124. Specifically, OCR engine evaluator 130 may apply each OCR engine 112 to each of the set of images 126 of the evaluation dataset 124 to generate an OCR engine output 114 for that OCR engine 112 on each image 126 of the evaluation dataset 124 (e.g., OCR engine 112a may be applied to each of the set of images 126 to generate a set of OCR engine outputs 114a corresponding to that OCR engine 112a, OCR engine 112b may be applied to each of the set of images 126 to generate a set of OCR engine outputs 114b corresponding to that OCR engine 112b, etc.). The OCR engine output 114 generated by an OCR engine 112 for an image 126 of the evaluation dataset 124 may include a set of characters 116 (e.g., character predictions) along with associated confidence levels 118 for those characters 116. These confidence values can, for example, be on a scale from 0-100 or 0 to 1.

It will be noted that certain OCR engines that it may be desired to utilize in an OCR system may generate confidence values or different types, or that have a different range of values. In some embodiments, then, in order to be able to utilize confidence values mutatis mutandis across OCR engines, confidence values from different or particular OCR engines may be normalized to a particular scale or value range, where that scale may (or may not be) based on the range of confidence values produced by one or more of the OCR engines 112 to be utilized by the OCR system 100. For purposes of ease of description herein, OCR engines will be described as generating confidence values in the range between 0 and 100, however, OCR engines that utilize other types or ranges of confidence values may be utilized in other embodiments with equal efficacy and all such embodiments are contemplated herein without loss of generality.

OCR engine evaluator 130 may then utilize ground truth data 128 of the evaluation data set 124 to evaluate the OCR engine output 114 generated by an OCR engine 112 for the set of images 126 of the evaluation dataset 124 to generate the trust list 122 for that OCR engine 112. In some embodiments, for example, the number of occurrences of each of a set of characters in the set of images 126 of the evaluation dataset 124 as included in the ground truth data 128 (e.g., along with the location of those characters in the set of images of the evaluation dataset) may be used to determine a count of the number of occurrences of each character in the set of images 126 of the evaluation dataset 124 (e.g., the actual number of occurrences of each character as indicated in the ground truth data 128). A count of the number of occurrences of each character that were correctly recognized by the OCR engine 112 can be determined from the OCR engine output 114 generated from the images 126 of the evaluation dataset 124 (e.g., and the ground truth data 128). In some embodiments, only one to one character matches between the OCR engine output 114 and the ground truth data 128 may be included in the character counts for the trust list 122 being generated. In this manner, no insertions, deletions, or segmentation errors may be counted. Additionally, (e.g., recognized) blanks may be discarded from such counts as well.

Thus, a generated trust list 122 for a corresponding OCR engine 112 may include, for each of a set of characters, the number of occurrences of that character in the images 126 of evaluation dataset 124 as determined from the ground truth data, 128 (referred to as the ground truth count) and an associated number of occurrences of that character that were correctly recognized by that OCR engine 112 in the images 126 of the evaluation dataset 128, as determined from the OCR engine output 114 generated by that OCR engine 112 and the ground truth data 128 for the evaluation dataset 124 (referred to as the correct count).

The (e.g., statistical) data included in the trust list 122 may also include a character confidence value for each of the set of characters included in the trust list 122. The character confidence value for a character for an OCR engine 112 may be determined by OCR engine evaluator 130 from the confidence levels 118 generated by that OCR engine 112 for occurrences of that character in each of the OCR engine outputs 114. In one particular embodiment, the character confidence value for a character for an OCR engine 112 may be an average confidence level for that character generated by that OCR engine 112 for instances where that character was correctly recognized by that OCR engine 112 in the set of images 126 of the evaluation dataset 124. The character confidence value can thus be a sum of all the confidence values 118 generated by the OCR engine 112 for that character (as included in the OCR engine output 114) for instances of that character that were correctly recognized by that OCR engine 112, divided by the number of occurrences of that character that were correctly recognized by that OCR engine 112 (e.g., as determined from the OCR engine output 114 for that OCR engine 112 and the ground truth data 128 of evaluation dataset 124).

These character confidence values for individual characters for an OCR engine 112 as included in a trust list 122 may be utilized to generate an overall confidence value for that OCR engine 112 (also referred to as an overall, or OCR engine, confidence value). An overall confidence value for an OCR engine 112 may be determined as an average of the confidence values for all of the individual character confidence values for that OCR engine 112 as included in the trust list 122 for that OCR engine. Thus, the overall confidence value for the OCR engine 112 is a sum of the individual character confidence values included in the trust list 122 divided by the number of characters in the trust list (or the number of characters which the OCR engine 112 is adapted to recognize).

In some embodiments, the trust list 122 for an OCR engine 112 may include characters that the OCR engine 112 may not be capable of recognizing. For these characters (that the OCR engine 112 cannot recognize), the trust list 122 may include that character, along with the number of occurrences of that character in the images 126 of the evaluation dataset 124 as indicated in the ground truth data 128 (the ground truth count for that character). The number of correctly recognized occurrences of that character (the correct count) and the character confidence value for that character may be specified as zero in the trust list 122.

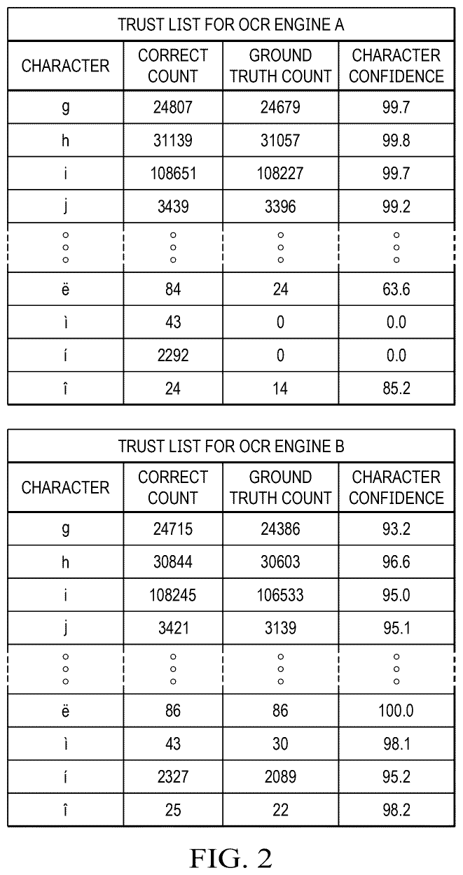

It may be useful to an understanding of embodiments to briefly discuss examples of such trust lists as depicted in FIG. 2. Here, two example trust lists are shown, a first example trust list for OCR engine “A” and a second example for OCR engine “B” where both of these example trust lists have been generated from the same evaluation dataset. Here, each trust list comprises a set of characters (“char”), where each of those characters is associated with a correct count (“correct count”) and a ground truth count (“ground truth count”) and a character confidence value (“char conf”), as discussed. It will be noted that in this example, only one to one character matches between the OCR engine output for OCR engine “A” and “B” and the ground truth data are included in the character counts for the trust lists being generated (e.g., which accounts for the difference in the ground truth counts for each example trust list. Additionally, it will be noted with respect these examples that OCR engine “A” may not (e.g., properly or effectively) recognize i-acute “i” and i with a grave “i”, thus the ground truth counts and character confidence values for those characters may be set to zero in the trust list for OCR engine “A”.

Returning to FIG. 1, as discussed, trust lists 112 generated by OCR data system 104 can then be deployed to (used to provision or update), or included with (e.g., installed with), deployed OCR system 102. Thus, when performing OCR on image 106 deployed OCR system 102 can evaluate OCR engine outputs 114 from the different OCR engines 112 based on these trust lists 112 to generate a final set of characters 110 for inclusion in character recognized document 108 for the image 106. This evaluation process involves matching corresponding characters in different OCR engine outputs 114 from the different OCR engines 112 and selecting a character from these corresponding characters to include in the final set of characters 110 for character recognized content 108 based on the trust lists 112 for the different OCR engines 112.

Specifically, OCR voting and selection engine 120 may determine corresponding characters 116 from each of the OCR engine outputs 114 generated by each of the OCR engines 112 for that image 106. These corresponding characters may be recognized characters 116 as included in the OCR engine output 114 from each OCR engine 112 that correspond to the same location, area, slot, etc. Thus, if the corresponding characters 116 from each of the OCR engines 112 are the same, there may be no need to perform any further comparison and that character 116 may be selected from inclusion in the final set of characters 110 recognized for that image 106 and included in character recognized content 108. If, however, there is a discrepancy between corresponding characters 116 in the OCR engine output 114 (e.g., the recognized characters from two or more OCR engines 112 corresponding to the same location or slot are different characters), OCR voting and selection engine 120 may make a comparison between the OCR engines 112 with respect to those different corresponding recognized characters 116 to select one of the different corresponding characters 116 for inclusion in the final set of characters 108 recognized for that image 106.

This comparison may be based on voting values determined for each of the OCR engines 112 based on the characters 116 recognized by that (or the other) OCR engines 112 and the trust lists 112 including the extrinsic data determined for those OCR engines 112. These voting values for each of the OCR engines can then be compared to select a corresponding character from one of the OCR engines for inclusion in the final set of characters recognized for an image.

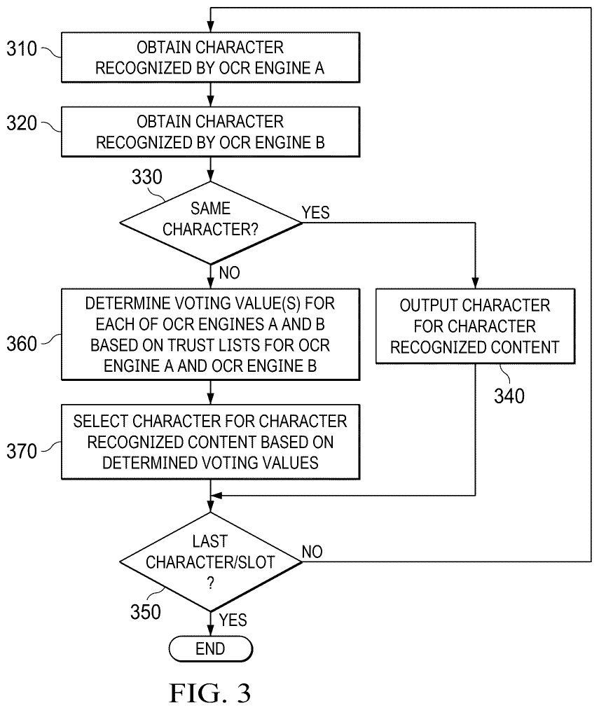

FIG. 3 depicts one embodiment of a method for extrinsic data driven character selection. It should be noted at this point that, for ease of presentation and discussion, examples and embodiments as discussed hereinafter may be presented or described with respect to the selection of a character for inclusion in a final set of characters for an image from two corresponding characters recognized by two different OCR engines. Embodiments as contemplated herein, however, may apply to the selection of a character from any number of corresponding characters recognized by any number of different OCR engines as will be understood by those of skill in the art.

Initially, then, a character recognized by one OCR engine (e.g., OCR engine A) from an image may be obtained (STEP 310), such as from an OCR engine output associated with that OCR engine (e.g., OCR engine A). Additionally, a corresponding character recognized by another OCR engine (e.g., OCR engine B) for that image may be obtained (STEP 320). Again, this corresponding character may be obtained from an OCR engine output associated with that other OCR engine (e.g., OCR engine B). If the corresponding characters from each of the OCR engines (e.g., OCR engines A and B) are the same (Y Branch of STEP 330) there may be no need to perform any further comparison and that character may be selected for inclusion in the final set of characters recognized for that image and included in character recognized content for that image (STEP 340). If that is the last character or last slot (Y Branch of STEP 350), the selection process may stop (e.g., and the character recognized content from the image returned or output). Otherwise (N Branch of STEP 350). A new pair of corresponding characters may be obtained (STEPS 310, 320) and the selection process repeated.

If, however, there is a discrepancy between the obtained corresponding characters (N Branch of STEP 330), voting values for each of the OCR engines (e.g., OCR engine A and OCR engine B) may be determined based on the trust lists (including extrinsic data determined) for those OCR engines (e.g., OCR engine A and OCR engine B) and the obtained corresponding characters (STEP 360). The voting values determined for each of the OCR engines (e.g., OCR engine A and OCR engine B) can then be compared to select one of the different corresponding characters recognized by those OCR engines for inclusion in the (final set of characters for the) character recognized content for that image (STEP 370). If that is the last character or last slot (Y Branch of STEP 350), the selection process may stop (e.g., and the character recognized content from the image returned or output). Otherwise (N Branch of STEP 350). A new pair of corresponding characters may be obtained (STEPS 310, 320) and the selection process repeated.

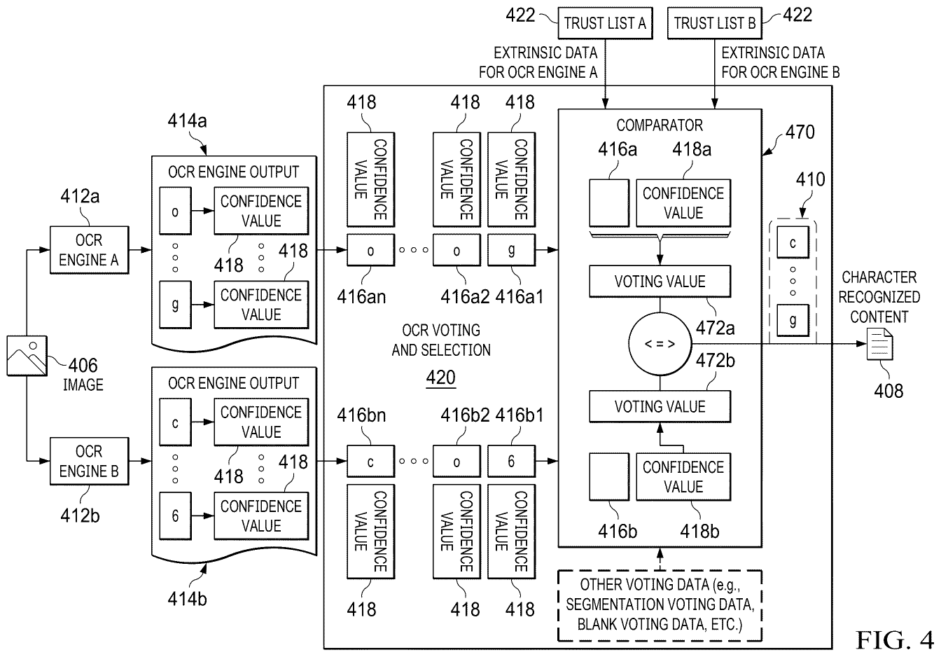

Moving now to FIG. 4, a block diagram of one embodiment of an OCR voting and selection engine 420 adapted to generate and compare voting values for OCR engines 412a, 412b for character selection in an OCR system is depicted. As discussed, an image 406 on which OCR is to be performed may be provided to OCR engine A 412a and OCR engine B 412b which each may perform OCR on the image 406 to generate a corresponding OCR engine output 414a, 41b. Each OCR engine output 414a, 414b output from the respective OCR engine 412a, 412b comprises a set of characters 416 determined from image 406 along with an associated confidence value 418 for those characters 416 (e.g., between 0 and 100). Once each OCR engine 412a, 412b has processed the image 406, OCR voting and selection engine 420 will evaluate the OCR engine outputs 414a, 414b to generate the final set of characters 410 for inclusion in character recognized content 408 for the image 406.

In particular, OCR voting and selection engine 420 may determine corresponding pairs of characters 416a, 416b from each OCR engine output 414a, 414b and provide corresponding characters 416a, 416b recognized by each OCR engine 412a, 412b from image 406 to comparator 470 to select one of the two characters 416a, 416b for inclusion in the final set of characters 410 for character recognized content 408. If the two characters 416a, 416b are not the same, comparator 470 may utilize extrinsic data determined for each OCR engine 412a, 412b, as included in respective trust lists 422a, 422b for those OCR engines 412a, 412b, to determine respective voting values 472a, 472b for each of those OCR engines 412a, 412b with respect to each of those characters 416a, 416b. These voting values 472a, 472b can then be compared to select one of the two characters 416a, 416b.

In one embodiment, these voting values 472a, 472b may be based on trust values determined for each OCR engine 412a, 412b, where those trust values are associated with the character 416a, 416b recognized by that OCR engine 412a, 412b or the character 416a, 416b recognized by the other OCR engine 412a, 412b. For example, a trust value for an OCR engine 412a, 412b for a character 416a, 416b may be a ratio of the ground truth count for that character 416a, 416b in the trust list 422a, 422b for that OCR engine 412a, 412b to the correct count for that character 416a, 416b in the trust list 422a, 422b for that OCR engine 412a, 412b. Other voting data may also be used in determining these voting values 472a, 472b, such as for example, segmentation voting data, blank voting data or other types of data that may be useful in selecting characters from OCR engine outputs.

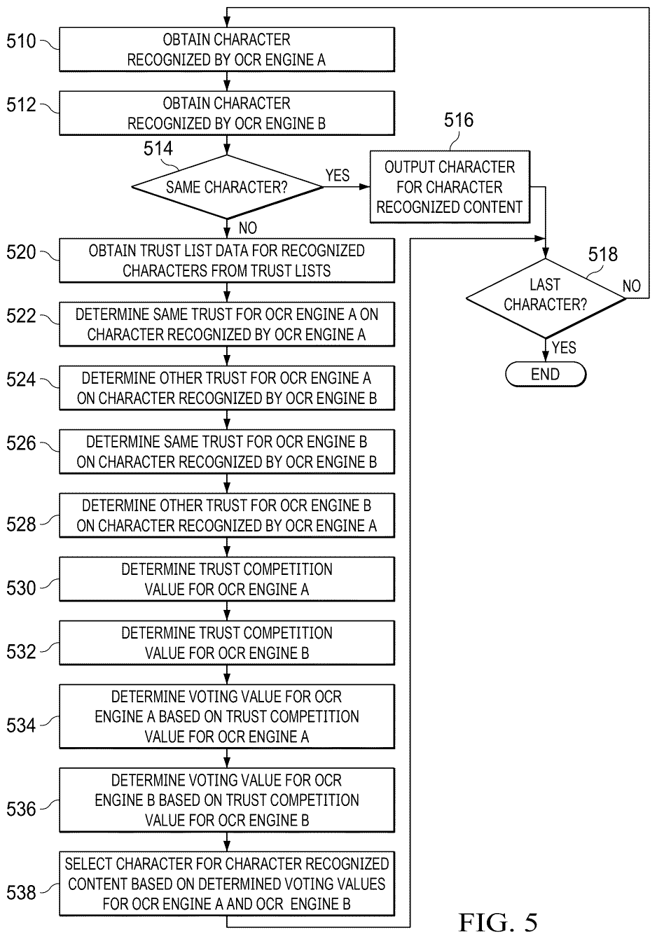

Looking at FIG. 5, one embodiment of a method for selecting a character from a corresponding pair of characters recognized by two OCR engines based on trust values is depicted. A character recognized by one OCR engine (referred to as OCR engine A for ease of reference) from an image may be obtained (STEP 510) from an OCR engine output from OCR engine A. A corresponding character recognized by another OCR engine (e.g., referred to as OCR engine B for ease of reference) for that image may also be obtained (STEP 512) from an OCR engine output from OCR engine B. If the corresponding characters from each of the OCR engines are the same (Y Branch of STEP 514) there may be no need to perform any further comparison and that character may be selected for inclusion in the final set of characters recognized for that image and included in character recognized content for that image (STEP 516). If that is the last character or last slot (Y Branch of STEP 518), the selection process may stop (e.g., and the character recognized content from the image returned or output). Otherwise (N Branch of STEP 518). A new pair of corresponding characters may be obtained (STEPS 510, 512) and the selection process repeated.

If, however, there is a discrepancy between the obtained corresponding characters (N Branch of STEP 514), voting values for OCR engine A and OCR engine B may be determined based on the trust lists for OCR engine A and OCR engine B and the corresponding characters recognized by each OCR engine. To determine these voting values, extrinsic data (e.g., the ground truth count, the correct count, or the character confidence value) may be obtained for OCR engine A from the trust list corresponding OCR engine A, where this extrinsic data may include data on both the character recognized by OCR engine A and the character recognized by OCR engine B. Similarly, extrinsic data (e.g., the ground truth count, the correct count, or the character confidence value) may be obtained for OCR engine B from the trust list corresponding OCR engine B, where this extrinsic data may include data on both the character recognized by OCR engine B and the character recognized by OCR engine A (STEP 520).

Using this extrinsic data a set of trust values may be determined for OCR engine and OCR engine B. In some cases, a threshold value may be utilized to place a ceiling or a floor on a trust value. For example, a generated trust value may be compared to a minimum value threshold (0.7) and if the generated trust value is below that minimum value threshold, the trust value may be set to that minimum value (e.g., 0.7). This may allow embodiments to account for a scenario where an OCR cannot recognize certain characters, or other scenarios where a correct count for that character in the trust list for OCR engine may be zero.

In one embodiment, therefore, a same trust value for OCR engine A may be determined as a ratio of the ground truth count and correct counts for the character recognized by OCR engine A as obtained from the trust list for OCR engine A (STEP 522). An other trust value for OCR engine A may be determined as a ratio of the ground truth count and correct counts for the character recognized by OCR engine B as obtained from the trust list for OCR engine A (STEP 524). A same trust value for OCR engine B may be determined as a ratio of the ground truth count and correct counts for the character recognized by OCR engine B as obtained from the trust list for OCR engine B (STEP 526), and an other trust value for OCR engine B may be determined as a ratio of the ground truth count and correct counts for the character recognized by OCR engine A as obtained from the trust list for OCR engine B (STEP 528).

The trust values can then be used to determine voting values for each of OCR engine A and OCR engine B with respect to the corresponding characters recognized by those OCR engines to select one of the different corresponding characters for inclusion in the final set of characters recognized for that image. Specifically, in certain embodiments, a trust competition value for each of OCR engine A and OCR engine B may be determined based on the same trust value and the other trust value determined for those OCR engines. Accordingly, a trust competition value for OCR engine A may be determined as a ratio between the same trust value for OCR engine A (e.g., the trust value for OCR engine A on the character recognized by OCR engine A) and the other trust value for OCR engine B (e.g., the trust value for OCR engine B on the character recognized by OCR engine A) (STEP 530). Similarly, a trust competition value for OCR engine B may be determined as a ratio between the same trust value for OCR engine B (e.g., the trust value for OCR engine B on the character recognized by OCR engine B) and the other trust value for OCR engine A (e.g., the trust value for OCR engine A on the character recognized by OCR engine B) (STEP 532).

The trust competition value determined for OCR engine A may then be used to determine a voting value for OCR engine A (STEP 534) and the trust competition value determined for OCR engine B may be used to determine a voting value for OCR engine B (STEP 536). Those voting values may then be compared to select one of the corresponding characters from OCR engine A or OCR engine B for inclusion in the final set of characters recognized for the image (STEP 538). If that is the last character (e.g., pair of corresponding characters) or last slot (Y Branch of STEP 518), the selection process may stop (e.g., and the character recognized content from the image returned or output). Otherwise (N Branch of STEP 518). A new pair of corresponding characters may be obtained (STEPS 510, 512) and the selection process repeated.

In one embodiment, for example, the trust competition value for each OCR engine may be used as the voting value for that OCR engine. However, in other embodiments the character confidence value for the character recognized by an OCR engine (e.g., as included in the trust list for that OCR engine) may be used in the generation of the voting trust for the OCR engine (e.g., the character confidence value for the respective character recognized by that OCR engine may be used in determining the voting value for that OCR engine).

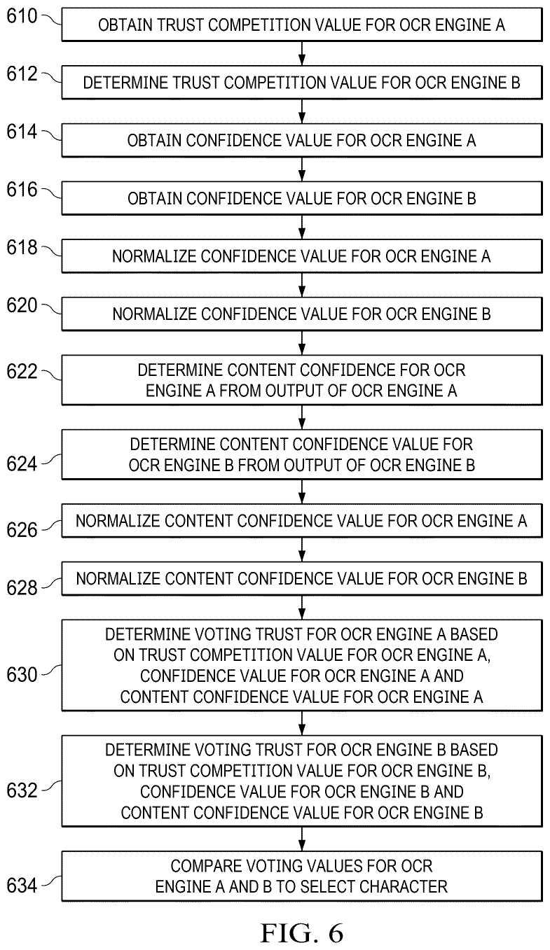

FIG. 6 depicts one embodiment of a method for determining and comparing voting values for OCR engines based on the trust competition values determined for those OCR engines. Here, a trust competition value for one OCR engine (again referred to as OCR engine A for ease of reference) may be obtained in association with a character recognized by OCR engine A (STEP 610). A trust competition value for another OCR engine (again referred to as OCR engine B for ease of reference) may be obtained in association with a corresponding character recognized by OCR engine B (STEP 612).

A character confidence value for OCR engine A for the character recognized by OCR engine A may be obtained from the trust list associated with OCR engine A (STEP 614). A character confidence value for OCR engine B for the character recognized by OCR engine B may be obtained from the trust list associated with OCR engine B (STEP 616). In some cases, this character confidence value may be normalized based on the (overall) confidence value for that OCR engine. Thus, in one embodiment, the overall confidence value determined for OCR engine A (e.g., the average value of the character confidence values for OCR engine A as determined from the trust list for OCR engine A) may be used to normalize the character confidence value for OCR engine A on the character recognized by OCR engine A (STEP 618). Similarly, the overall confidence value determined for OCR engine B (e.g., the average value of the character confidence values for OCR engine B as determined from the trust list for OCR engine B) may be used to normalize the character confidence value for OCR engine B on the character recognized by OCR engine B (STEP 620).

Additionally, in certain embodiments a content confidence value may be utilized in determining the voting value for an OCR engine. This content confidence value may be determined by summing all the confidence values for all characters in the OCR engine output generated by that OCR engine for that image. As such, a content confidence value for OCR engine A on the image may be determined by summing all the confidence values for all characters in the OCR engine output generated for the image by OCR engine A (STEP 622). A content confidence value for OCR engine B on the image may likewise be determined by summing all the confidence values for all characters in the OCR engine output generated for the image by OCR engine B (STEP 624).

Again, in certain instances this content confidence value may be normalized based on the (overall) confidence value for that OCR engine and this normalized content confidence value may be used in determining the voting value for that OCR engine. In one embodiment, then, the overall confidence value determined for OCR engine A may be used to normalize the content confidence value for OCR engine A on the image (STEP 626) and the overall confidence value determined for OCR engine B may be used to normalize the content confidence value for OCR engine B on the character recognized by OCR engine B (STEP 628).

The two voting values determined for the two different OCR engines (A and B) in association with the two different corresponding characters recognized in an image by those OCR engines may then be determined (STEPS 630, 632). This voting value for OCR engine A may be determined based on one or more of the trust competition value for OCR engine A, the (e.g., normalized) character confidence value for OCR engine A, and the (e.g., normalized) content confidence value for OCR engine A, while the voting value for OCR engine B may be determined based on one or more of the trust competition value for OCR engine B, the (e.g., normalized) character confidence value for OCR engine B, and the (e.g., normalized) content confidence value for OCR engine B. Moreover, in particular embodiments, the effect of this (e.g., normalized) content confidence value (or the (e.g., normalized) character confidence value)) on the voting value determined for an OCR engine (e.g., A or B) may be reduced by applying some reduction function (e.g., a square root) to the (e.g., normalized) content confidence value or (e.g., normalized) character confidence values and using the result of this reduction function applied to those values in determining the voting value for the OCR engine (e.g., A or B).

Once the voting values for OCR engine and OCR engine B are determined based on their corresponding recognized characters, the voting value for OCR engine A and OCR engine B may be compared to determine which of those corresponding characters to select for inclusion in the final set of characters recognized for that image by the OCR system (STEP 634). For example, a direct comparison with the voting values may be used such that the character recognized by the OCR engine (e.g., A or B) with the greatest voting value may be selected for inclusion in the final set of characters. Alternatively, a voting threshold may be used to bias the determination of which character to select in favor (or against) one of the OCR engines (e.g., when one OCR engine is a more, or less, trusted OCR engine). To illustrate, if OCR engine B is more trusted than OCR engine A the character recognized by OCR engine A may only be selected instead of the corresponding character recognized by OCR engine B if the voting value determined for OCR engine A is greater than the voting value determined for OCR engine B by some amount (e.g., the voting threshold).

It may now be useful to illustrate a particular example of character selection between corresponding characters recognized by two OCR engines, OCR engine A and OCR engine B. With respect to this example, it will be understood that ‘content’ means the set of all characters of an actual OCR process performed by an OCR engine (A or B) on an image. This content could be a single character, single word, single line, entire page, multiple pages, etc.

Moreover, with respect to this example, the following will be understood:
c: indicates a general character or character code.
   E: indicates an OCR engine (e.g., A or B).
Eo: indicates other OCR engine with respect to Engine E.
cr: indicates an actual recognized character by an OCR Engine and being compared for selection
p: indicates (e.g., the complete) actual recognized content from an image (e.g., OCR engine output generated for the image)
char conf (cr,E): The confidence of the OCR engine E with respect to the character recognized by OCR engine E (e.g., the character being compared for selection), as obtained from the OCR engine output for OCR engine E
content conf (p,E): indicates the confidence of the OCR engine (E) on recognized content (p): the arithmetic average of all character confidences in the OCR engine output for that content
overall conf (E): The overall confidence level of OCR engine E: the arithmetical average of all the character average confidences in the trust list of OCR engine E.
correctcount (c,E): The correct count for the character c for OCR engine E (e.g., as determined from the trust list for OCR engine E)
groundtruthcount (c,E): The ground truth count for the character c for OCR engine E (e.g., as determined from the trust list for OCR engine E)

The values for each of OCR engine A and B for determining a voting value may thus be determined as follows:

Trust value for OCR engine E on character c (c,E)=correctcount (c,E)/groundtruthcount (c,E) (a minimum value may be used here, such as 0.7, to ensure the trust value is always at least that minimum value)

$$Trust competition value for OCR engine E one a character c - ( c , E ) = Trust value ( c , E ) / Trust value ( c , Eo )$$

$$Normalized character confidence for recongnized character - ( cr , E ) = char conf ( cr , E ) / overall conf$$

$$Normalized content confidence value ( p , E ) = content conf ( p , E ) / overall conf ( E )$$

$$Voting value ( cr , E ) = Trust comp . \cdot Norm conf . \cdot Sqrt ( Norm page conf . )$$

$$Selection Preference = Voting trust ( E 2 ) - Voting trust ( E 1 ) \geq Voting threshold ( e . g . , 25 )$$

An actual numerical example is illustrated below. Suppose, for purposes of this example, that OCR engine A and OCR engine B perform OCR on an image to generate two OCR engine outputs, and from these determined OCR engine outputs it is determined that the content confidence value for OCR engine A is 99.251 while the content confidence value for OCR engine B is 98.812. Moreover, suppose that two corresponding characters are obtained from these OCR engine outputs, where the character recognized by OCR engine A is character 105 (‘i’) with an associated character confidence value of 98 while the character recognized by OCR engine B is character 237 (‘i’) with an associated character confidence value of 100. Furthermore, assume the trust lists for OCR engine A and OCR engine B are the (partial) trust lists depicted in FIG. 2 with the (partial) trust list for OCR engine A being on the left side of the figure, and that OCR engine A is a preferred OCR engine. Also, assume that the overall confidence level for OCR engine A is determined to be 97.058 and the overall confidence level for OCR engine B is determined to be 94.663.

One of these characters may be selected using the determined values as follows:
A Trust value to A Char (same trust value for OCR engine A):

$$0.996 = max ( 108 \; 227 / 108651 , 0.7 )$$

A Trust to B Char (other trust value for OCR engine A):

$$0.7 = max ( 0 / 2292 , 0.7 )$$

B Trust to B Char (same trust value for OCR engine B):

$$0.898 = max ( 2089 / 2327 , 0.7 )$$

B Trust to A Char (other trust value for OCR engine B):

$$0.984 = max ( 106533 / 108245 , 0.7 )$$

Trust competition value for OCR engine A:

$$1. 012 = 0 \text{.996} / 0.984$$

Trust competition value for OCR engine B:

$$1. 282 = 0.898 / 0.7$$

(Normalized) character confidence value for (character recognized by) OCR engine A:

$$1. 010 = 98 / 97.058$$

(Normalized) character confidence value for (character recognized by) OCR engine B:

$$1. 056 = 100 / 94.663$$

(Normalized) content confidence value for (character recognized by) OCR engine A:

$$1. 023 = 99.2 \; 51 / 97.058$$

(Normalized) content confidence value for (character recognized by) OCR engine B:

$$1. 044 = 98.8 \; 12 / 94.663$$

Voting value for OCR engine A:

$$1. 034 = 1.012 ⋆ 1010 ⋆ s q r t ( 1.023 )$$

Voting value for OCR engine B:

$$1. 381 = 1.282 ⋆ 1.056 ⋆ s q r t ( 1.044 )$$

Selection Preference based on preference for OCR engine A: 0.347=1.381−1.034>0.025

Thus, for this example, as the difference between the voting value for OCR engine B and the voting value for OCR engine A is greater than the voting threshold (e.g., 025), character 237 (‘i’) recognized by OCR engine B may be selected for inclusion in the final set of recognized characters for the image processed by both OCR engine A and OCR engine B.

Although the invention has been described with respect to specific embodiments thereof, these embodiments are merely illustrative, and not restrictive of the invention. The description herein of illustrated embodiments of the invention is not intended to be exhaustive or to limit the invention to the precise forms disclosed herein (and in particular, the inclusion of any particular embodiment, feature or function is not intended to limit the scope of the invention to such embodiment, feature or function). Rather, the description is intended to describe illustrative embodiments, features and functions in order to provide a person of ordinary skill in the art context to understand the invention without limiting the invention to any particularly described embodiment, feature or function. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention.

Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

Reference throughout this specification to “one embodiment”, “an embodiment”, or “a specific embodiment” or similar terminology means that a particular feature, structure, or characteristic described in connection with the embodiment is included in at least one embodiment and may not necessarily be present in all embodiments. Thus, respective appearances of the phrases “in one embodiment”, “in an embodiment”, or “in a specific embodiment” or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the invention.

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

Embodiments discussed herein can be implemented in a computer communicatively coupled to a network (for example, the Internet), another computer, or in a standalone computer. As is known to those skilled in the art, a suitable computer can include a central processing unit (“CPU”), at least one read-only memory (“ROM”), at least one random access memory (“RAM”), at least one hard drive (“HD”), and one or more input/output (“I/O”) device(s). The I/O devices can include a keyboard, monitor, printer, electronic pointing device (for example, mouse, trackball, stylus, touch pad, etc.), or the like.

ROM, RAM, and HD are computer memories for storing computer-executable instructions executable by the CPU or capable of being compiled or interpreted to be executable by the CPU. Suitable computer-executable instructions may reside on a computer readable medium (e.g., ROM, RAM, and/or HD), hardware circuitry or the like, or any combination thereof. Within this disclosure, the term “computer readable medium” is not limited to ROM, RAM, and HD and can include any type of data storage medium that can be read by a processor. For example, a computer readable medium may refer to a data cartridge, a data backup magnetic tape, a floppy diskette, a flash memory drive, an optical data storage drive, a CD-ROM, ROM, RAM, HD, or the like. The processes described herein may be implemented in suitable computer-executable instructions that may reside on a computer readable medium (for example, a disk, CD-ROM, a memory, etc.). Alternatively, the computer-executable instructions may be stored as software code components on a direct access storage device array, magnetic tape, floppy diskette, optical storage device, or other appropriate computer readable medium or storage device.

Any suitable programming language can be used to implement the routines, methods or programs of embodiments of the invention described herein, including C, C#, C++, Java, JavaScript, HTML, or any other programming or scripting code, etc. Other software/hardware/network architectures may be used. For example, the functions of the disclosed embodiments may be implemented on one computer or shared/distributed among two or more computers in or across a network. Communications between computers implementing embodiments can be accomplished using any electronic, optical, radio frequency signals, or other suitable methods and tools of communication in compliance with known network protocols.

Different programming techniques can be employed such as procedural or object oriented. Any particular routine can execute on a single computer processing device or multiple computer processing devices, a single computer processor or multiple computer processors. Data may be stored in a single storage medium or distributed through multiple storage mediums, and may reside in a single database or multiple databases (or other data storage techniques). Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. The routines can operate in an operating system environment or as stand-alone routines. Functions, routines, methods, steps and operations described herein can be performed in hardware, software, firmware or any combination thereof.

Embodiments described herein can be implemented in the form of control logic in software or hardware or a combination of both. The control logic may be stored in an information storage medium, such as a computer readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention.

It is also within the spirit and scope of the invention to implement in software programming or code an of the steps, operations, methods, routines or portions thereof described herein, where such software programming or code can be stored in a computer readable medium and can be operated on by a processor to permit a computer to perform any of the steps, operations, methods, routines or portions thereof described herein. The invention may be implemented by using software programming or code in one or more general purpose digital computers, by using application specific integrated circuits, programmable logic devices, field programmable gate arrays, optical, chemical, biological, quantum or nanoengineered systems, components and mechanisms may be used. In general, the functions of the invention can be achieved by any means as is known in the art. For example, distributed, or networked systems, components and circuits can be used. In another example, communication or transfer (or otherwise moving from one place to another) of data may be wired, wireless, or by any other means.

A “computer readable medium” may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory. Such a computer readable medium shall generally be machine readable and include software programming or code that can be human readable (e.g., source code) or machine readable (e.g., object code). Examples of non-transitory computer readable media can include random access memories, read-only memories, hard drives, data cartridges, magnetic tapes, floppy diskettes, flash memory drives, optical data storage devices, compact-disc read-only memories, and other appropriate computer memories and data storage devices. In an illustrative embodiment, some or all of the software components may reside on a single server computer or on any combination of separate server computers. As one skilled in the art can appreciate, a computer program product implementing an embodiment disclosed herein may comprise one or more non-transitory computer readable media storing computer instructions translatable by one or more processors in a computing environment.

A “processor” includes any hardware system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real-time,” “offline,” in a “batch mode,” etc. Portions of processing can be performed at different times and at different locations, by different (or the same) processing systems.

It will also be appreciated that one or more of the elements depicted in the drawings/figures can also be implemented in a more separated or integrated manner, or even removed or rendered as inoperable in certain cases, as is useful in accordance with a particular application. Additionally, any signal arrows in the drawings/Figures should be considered only as exemplary, and not limiting, unless otherwise specifically noted.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited to only to those elements but may include other elements not expressly listed or inherent to such process, product, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present).

As used herein ordinal numbers (e.g., first, second, third, etc.) may be used as an adjective for an element. The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element may be distinct from a second element, and the first element may encompass more than one element and succeed (or precede) the second element in an ordering of elements.

Although the foregoing specification describes specific embodiments, numerous changes in the details of the embodiments disclosed herein and additional embodiments will be apparent to, and may be made by, persons of ordinary skill in the art having reference to this disclosure. In this context, the specification and figures are to be regarded in an illustrative rather than a restrictive sense, and all such modifications are intended to be included within the scope of this disclosure.

What is claimed is:

1. A method for character selection in an OCR system, the method comprising:
obtaining a first OCR engine output resulting from performing OCR on an image with a first OCR engine;
obtaining a second OCR engine output resulting from performing OCR on the image with a second OCR engine;
obtaining a first trust list associated with the first OCR engine, wherein the first trust list comprises first extrinsic data on the first OCR engine, the first extrinsic data determined based on performance of the first OCR engine on an evaluation dataset;
obtaining a second trust list associated with the second OCR engine, wherein the second trust list comprises second extrinsic data on the second OCR engine, the second extrinsic data determined based on performance of the second OCR engine on an evaluation dataset; and
selecting a final set of characters recognized for the image based on the first OCR engine output, the second OCR engine output, the first trust list and the second trust list.

2. The method of claim 1, wherein selecting a final set of characters recognized for the image comprises:
obtaining a first character recognized by the first OCR engine from the first OCR engine output;
obtaining a corresponding second character recognized by the second OCR engine from the second OCR engine output;
determining a first voting value for the first OCR engine based on performance of the first OCR engine associated with the first character or second character as determined from the first trust list;
determining a second voting value for the second OCR engine based on performance of the second OCR engine associated with the first character or second character as determined from the second trust list; and
comparing the first voting value and the second voting value to select the first character or the second character.

3. The method of claim 2, wherein the first voting value is based on a first same trust value based on performance of the first OCR engine associated with the first character and a first other trust value based on performance of the first OCR engine associated with the second character and the second voting value is based on a second same trust value based on performance of the second OCR engine associated with the second character and a second other trust value based on performance of the second OCR engine associated with the first character.

4. The method of claim 3, wherein the first voting value is based on a first trust competition value comprising a ratio between the first same trust value and the first other trust value and the second voting value is based on a second trust competition value comprising a ratio between the second same trust value and the second other trust value.

5. The method of claim 4, wherein the first voting value is determined based on a first character confidence value determined by the first OCR engine for the first character and the second voting value is determined based on a second character confidence value determined by the second OCR engine for the second character.

6. The method of claim 5, wherein the first character confidence value is normalized by a first overall confidence level for the first OCR engine determined based on the first trust list and the second character confidence value is normalized by a second overall confidence level for the second OCR engine determined based on the second trust list.

7. The method of claim 1, wherein the first trust list comprises a set of characters, each character associated with a first ground truth count of that character in the evaluation data set, a first correct character count of instances of that character correctly recognized by the first OCR engine in the evaluation dataset and a first character confidence value for that character indicating an average of character confidence values reported by the first OCR engine in association with the evaluation dataset and the second trust list comprises the set of characters, each character associated with a second ground truth count of that character in the evaluation data set, a second correct character count of instances of that character correctly recognized by the second OCR engine in the evaluation dataset and a second character confidence value for that character indicating an average of character confidence values reported by the second OCR engine in association with the evaluation dataset.

8. A non-transitory computer readable medium, comprising instructions for:
obtaining a first character recognized by the first OCR engine from the first OCR engine output;
obtaining a corresponding second character recognized by the second OCR engine from the second OCR engine output;
determining a first voting value for the first OCR engine based on performance of the first OCR engine associated with the first character or second character as determined from the first trust list;
determining a second voting value for the second OCR engine based on performance of the second OCR engine associated with the first character or second character as determined from the second trust list; and
comparing the first voting value and the second voting value to select the first character or the second character.

9. The non-transitory computer readable medium of claim 8, wherein selecting a final set of characters recognized for the image comprises:
obtaining a first character recognized by the first OCR engine from the first OCR engine output;
recognizing a corresponding second character recognized by the second OCR engine from the second OCR engine output;
determining a first voting value for the first OCR engine based on performance of the first OCR engine associated with the first character or second character as determined from the first trust list;
determining a second voting value for the second OCR engine based on performance of the second OCR engine associated with the first character or second character as determined from the second trust list; and
comparing the first voting value and the second voting value.

10. The non-transitory computer readable medium of claim 9, wherein the first voting value is based on a first same trust value based on performance of the first OCR engine associated with the first character and a first other trust value based on performance of the first OCR engine associated with the second character and the second voting value is based on a second same trust value based on performance of the second OCR engine associated with the second character and a second other trust value based on performance of the second OCR engine associated with the first character.

11. The non-transitory computer readable medium of claim 10, wherein the first voting value is based on a first trust competition value comprising a ratio between the first same trust value and the first other trust value and the second voting value is based on a second trust competition value comprising a ratio between the second same trust value and the second other trust value.

12. The non-transitory computer readable medium of claim 11, wherein the first voting value is determined based on a first character confidence value determined by the first OCR engine for the first character and the second voting value is determined based on a second character confidence value determined by the second OCR engine for the second character.

13. The non-transitory computer readable medium of claim 12, wherein the first character confidence value is normalized by a first overall confidence level for the first OCR engine determined based on the first trust list and the second character confidence value is normalized by a second overall confidence level for the second OCR engine determined based on the second trust list.

14. The non-transitory computer readable medium of claim 8, wherein the first trust list comprises a set of characters, each character associated with a first ground truth count of that character in the evaluation data set, a first correct character count of instances of that character correctly recognized by the first OCR engine in the evaluation dataset and a first character confidence value for that character indicating an average of character confidence values reported by the first OCR engine in association with the evaluation dataset and the second trust list comprises the set of characters, each character associated with a second ground truth count of that character in the evaluation data set, a second correct character count of instances of that character correctly recognized by the second OCR engine in the evaluation dataset and a second character confidence value for that character indicating an average of character confidence values reported by the second OCR engine in association with the evaluation dataset.

15. A system, comprising:
a processor;
a non-transitory computer readable medium, comprising instructions for:
obtaining a first OCR engine output resulting from performing OCR on an image with a first OCR engine;
obtaining a second OCR engine output resulting from performing OCR on the image with a second OCR engine;
obtaining a first trust list associated with the first OCR engine, wherein the first trust list comprises first extrinsic data on the first OCR engine, the first extrinsic data determined based on performance of the first OCR engine on an evaluation dataset;
obtaining a second trust list associated with the second OCR engine, wherein the second trust list comprises second extrinsic data on the second OCR engine, the second extrinsic data determined based on performance of the second OCR engine on an evaluation dataset; and
selecting a final set of characters recognized for the image based on the first OCR engine output, the second OCR engine output, the first trust list and the second trust list.

16. The system of claim 15, wherein selecting a final set of characters recognized for the image comprises:
obtaining a first character recognized by the first OCR engine from the first OCR engine output;
obtaining a corresponding second character recognized by the second OCR engine from the second OCR engine output;
determining a first voting value for the first OCR engine based on performance of the first OCR engine associated with the first character or second character as determined from the first trust list;
determining a second voting value for the second OCR engine based on performance of the second OCR engine associated with the first character or second character as determined from the second trust list; and
comparing the first voting value and the second voting value to select the first character or the second character.

17. The system of claim 16, wherein the first voting value is based on a first same trust value based on performance of the first OCR engine associated with the first character and a first other trust value based on performance of the first OCR engine associated with the second character and the second voting value is based on a second same trust value based on performance of the second OCR engine associated with the second character and a second other trust value based on performance of the second OCR engine associated with the first character.

18. The system of claim 17, wherein the first voting value is based on a first trust competition value comprising a ratio between the first same trust value and the first other trust value and the second voting value is based on a second trust competition value comprising a ratio between the second same trust value and the second other trust value.

19. The system of claim 18, wherein the first voting value is determined based on a first character confidence value determined by the first OCR engine for the first character and the second voting value is determined based on a second character confidence value determined by the second OCR engine for the second character.

20. The system of claim 19, wherein the first character confidence value is normalized by a first overall confidence level for the first OCR engine determined based on the first trust list and the second character confidence value is normalized by a second overall confidence level for the second OCR engine determined based on the second trust list.

21. The system of claim 15, wherein the first trust list comprises a set of characters, each character associated with a first ground truth count of that character in the evaluation data set, a first correct character count of instances of that character correctly recognized by the first OCR engine in the evaluation dataset and a first character confidence value for that character indicating an average of character confidence values reported by the first OCR engine in association with the evaluation dataset and the second trust list comprises the set of characters, each character associated with a second ground truth count of that character in the evaluation data set, a second correct character count of instances of that character correctly recognized by the second OCR engine in the evaluation dataset and a second character confidence value for that character indicating an average of character confidence values reported by the second OCR engine in association with the evaluation dataset.
